(19) United States
(12) Patent Application Publication
(10) Pub. No.: US 2007/0069516 A1
(43) Pub. Date: Mar. 29, 2007

(54) Wearable PVC-based personal emergency contact tag

(76) Inventors: Carole L. Skokos, Littleton, CO (US); Peter S. Skokos, Littleton, CO (US)

Correspondence Address: Carole L. Skokos, 7217 Red Mesa Ct., Littleton, CO, 80125, US

(21) Appl. No.: 11/233,237

(22) Filed: Sep. 23, 2005

(51) Int. Cl. B42D 15/00; G08B 23/00

(52) U.S. Cl. 283/75; 340/573.1

(57) ABSTRACT

A personal emergency contact tag comprised of lightweight, Polyvinyl Chloride (PVC) that is digitally and thermally printed and secured to the waist, wrist, arm or ankle with a belt or band. It presents a solution for athletes, children and the elderly in need of visible, comfortable, water/weather resistant, inexpensive and convenient emergency contact information that can be worn to provide first responders with identification and emergency contact information and blood type in case of accident or emergency.

### FIELD OF THE INVENTION

The present invention relates to a personal emergency contact tag comprised of light-weight, Polyvinyl Chloride or PVC (the primary material used for typical plastic cards) that is secured to the waist, wrist, arm or ankle with a belt or band for the purpose of providing first responders with critical identification, contact information and blood type in the case of an accident or emergency.

### BACKGROUND OF THE INVENTION

This invention was conceived after witnessing an ever-increasing number of runners, cyclists, swimmers, and other athletes training away form home without personal identification or emergency contact information on their person. Without emergency contact information available, it is almost impossible for first responders at the scene of an accident to identify the injured party or contact anyone, other than 911, for help. Further research shows a huge deficit in adequate emergency contact information to benefit the elderly, school-age children, and pre-school age children.

Because much of today's trim-line athletic gear specifically designed for runners, cyclists, swimmers, and other high-endurance sports does not include secure pockets, many athletes do not carry any form of identification with them when they train. Swim suits typically have no pocket at all to carry identification, nor do wet suits—and, if they did, most current identification is paper-based and cannot withstand water and chemicals.

For athletes who do carry identification, it is usually in the form of a driver's license slipped into a small pocket or pouch. A drivers license includes limited information for first responders since it only includes a name and address and not a phone number, blood type, or medical information. Another drawback to using a license as a form of emergency contact information is that it requires the user to consistently remove their driver's license from their wallet or purse, which increases the likelihood of misplacing the license or forgetting to replace it. Finally, many drivers licenses also include a social security number which, if lost, may lead to instances of identity theft.

Using a driver's license as a form of emergency contact information is not an option for parents concerned about their children's well-being especially when they are away form home at daycare, school, class trips, birthday parties, sports practices, and other activities—because children are no issued a driver's license until the are at least 16 years old in most states.

Similarly, many elderly do not have valid drivers licenses and of they do, this form of identification does not provide vital emergency contact information in case of emergency.

Today, there are manufacturers that produce identification tags fashioned from metal which are embossed with emergency contact information. The metal is typically heavy and requires the emergency contact information to be etched into the piece. The material heats up from exposure to the sun, which makes it quite uncomfortable against the wearer's skin. Engraving metal bracelets, as is well known in the art, is both expensive and time consuming.

Metal identification tags that are worn via a necklace or chain have several drawbacks. The constant motion of many sports makes a dangling necklace-type identification tag quite uncomfortable for the wearer. In this instance, many athletes will tuck the tag under their clothing which greatly reduces the chances of a first responder locating the critical information in case of emergency. On the other hand, men who prefer to exercise without a shirt in the warm weather will likely opt not to wear the necklace because of the heat discomfort and repetitive motion annoyance.

Furthermore, metal, necklace-type identification tags are not safe for children because they can cause a strangulation hazard in many scenarios including sports, play and sleep.

In the case of adults and the elderly, metal tags are typically considered unattractive and unsuitable for daily wear. This impression results in the tags not being worn, or being tucked beneath clothing which, again, greatly reduces the chances of a first responder locating the critical information in case of emergency.

Various personal information packets, cards, and tags have also been attempted in the prior art. Stephens, U.S. Pat. No. 5,380,046, teaches a secured personal information packet that can be carried by a child to provide personalized identification information about the child. The packet includes a paper information card that is filled out by the parents and sealed within a plastic envelope. Taft, U.S. Pat. No. 4,892,335, also teaches a card construction that is also useful for protecting an information-bearing card within a protective coating. However, these forms are not made to withstand the rigors of daily wear or use and pose the same logistical issues as carrying a driver's license. They cannot be adequately, safely, and obviously carried by a person involved in sports or other activities in which a wallet or purse is not suitable.

While there are many other forms of identification and emergency contact information available, most are not multipurpose, water/weather resistant, inexpensive, or easily worn on different parts of the body for maximum comfort and visibility.

### SUMMARY OF THE INVENTION

The present invention in its various aspects addresses the above problems with current forms of identification and emergency contact tags. It presents a solution for athletes, children and the elderly in need of visible, comfortable, and convenient emergency contact information that can he worn on various parts of the body to provide first responders with identification and contact phone numbers in case emergency.

In accordance with a preferred embodiment of the invention, the described emergency contact tag is comprised of Polyvinyl Chloride, which is the primary material used for typical plastic cards. Today, PVC cards are used for hundreds of applications including credit cards, gift cards, reward programs, corporate ID badges, and more.

This wearable, emergency contact tag would be designed to be compact and unobtrusive—in a size ranging from a 1 inch high by 2 inch wide by 1 millimeter thick to 1.5 inches high by 3 inches wide by 1 millimeter thick. The size of the tag could be altered depending on the amount of information the wearer would like to have printed on the tag and depending on preferred style. The tags could be produced in any color as long as the printed information can he easily read. For example, a dark-colored card would require a light-colored text and vice versa.

In accordance with the preferred embodiment of the present invention, the wearer's emergency contact information would be thermally, digitally printed onto the PVC-based emergency contact tag directly from a computer system using a card printer specifically designed to transfer ink to a plastic card using either dye sublimation or thermal transfer printing. A process that is inexpensive and can be quickly completed by any organization or retail outfit that currently uses plastic card printing technology to produce full-size access badges, gift cards, credit cards, etc.

To ensure adequate emergency contact information, the preferred embodiments include at least the following printed information: A statement that clearly describes the usefulness of the tag with language that indicates “Emergency Contact Information;” the wearer's name; an emergency contact phone number; wearer's blood type; other special medical needs. The cards can also be customized with an organization's logo or other printable design.

Because PVC-based plastic cards can be printed on the front side only or on both sides, it is preferred that the personal identity tags be produced with information on both sides. To integrate a level of security an privacy, the printed personal information would be produced on one side only. In accordance with the preferred embodiments, the reverse side of the card would be printed with a statement that clearly identifies the tag as an emergency contact tag that includes critical information on the reverse side to assist first responders in case of emergency. This design allows wearers keep the personal information safely on the inside of the tag while ensuring that the usefulness of the tag is evident to first responders.

An alternative version of the present invention integrates a matte, write-on surface in the space that incorporates the thermally-printed name, phone number, and blood type described in the original version above. While the tag would still be thermally-printed on both sides and include a pre-printed statement that clearly indicates the usefulness of the tag with language that indicates “Emergency Contract Information,” the wearer would have the flexibility to write on the matte surface of the tag with indelible ink. This format increases the usefulness of the invention by allowing the wearer to quickly update his/her emergency contract information without third-party intervention or a digital, thermal printer.

The PVC-based emergency contract tag, in preferred embodiment, would include a slot on each opposing end spanning approximately 80 percent of the height of the tag. The slot opening would be approximately one centimeter wide to accommodate a belt-style created from flexible fabric or webbed belting material.

A key to the invention's functionality and success is visibility—ensuring that the emergency contact information is prominently visible to first responders in emergency situations. As noted above, while many current forms of identification include limited information, they are also not prominently worn or displayed usually tucked under clothing or in a concealed pocket. To address this, the preferred embodiment of the invention would be such that the emergency contact tag is attached to a waistband or armband which is then worn directly on the arm or waist, worn over clothing, or securely attached at the waist through the garment's belt loops. Preferably, added security would be gained by using a band or belt comprised of reflective material.

In accordance with this invention's preferred embodiments, the emergency contact tag, when threaded onto a waist- or arm-belt, eliminates the bouncing and shifting that occurs with necklace-type identity tags. As noted above, the discomfort caused by the repetitive motion of the dangling tag results in the wearer tucking it beneath clothing or removing it altogether.

Because the preferred embodiment of the invention is designed to be only approximately 1 inch by 2 inch by 1 millimeter made from a plastic-based material, it is intrinsically lightweight and does not absorb heat in the way metal identification tags do. Therefore, if the emergency contact tag is worn against the skin, there is no risk of discomfort from weight or excessive heat.

The present invention, being designed from thermally-printed PVC material, is both water proof and sweat proof. It will withstand regular washing, routine attaching and removing, and swimming. With this design, there is virtually no risk of loss destruction, fading, illegibility, or shrinkage.

The present invention, being designed from PVC material with a write-on matte surface, is both water proof and sweat proof. When printed with indelible ink, it will withstand washing, routine attaching and removing, and swimming. Depending on several factors, however, the emergency tag with the write-on matte surface may sustain some fading which can be addressed by reapplying the contact information with indelible ink.

A dual use for the current invention includes optional bar-coding to serve as both entry and identification into workout facilities, daycare centers, nursing homes, and pre-schools. The pre-printed emergency contact tag would allow the member to both scan into the facility and then visibly wear the emergency tag for identity and emergency purposes.

The emergency contact tag in accordance with the preferred embodiment of the present invention thus overcomes the drawbacks of current and prior identification forms noted above. The emergency contact tag can be worn comfortably and conveniently during any type of physical activity or sport without heat or motion discomfort. It can be worn by anyone—specifically those who do not or cannot carry adequate emergency contact identification including athletes, the elderly and children. The PVC-based material is lightweight, water- and sweat-proof, can be developed with a number of attractive designs, can be effortlessly printed with up-to-date contact information, or written on by the wearer. With a waistband or armband attachment, the described emergency contact tag is effortlessly attachable to the body and fully visible to first responders in the case of an emergency.

### BRIEF DESCRIPTION OF THE DRAWINGS

The above and other objects, features and advantages of the invention will become more apparent from the following description of certain preferred embodiments thereof, when taken in conjunction with the accompanying drawings in which:

FIG. 1 is a perspective view of the emergency contact tag and waist band only depicted in accordance with the preferred embodiment of the invention.

FIG. 2 is a detailed view of only the emergency contact tag and the preferred information that would be thermally-printed on each side.

FIG. 3 is a detailed view of only the emergency contact tag with the matte, write-on surface and the preferred information that would be manually-printed on one side and thermally-printed on the other.

FIG. 4 is a detailed view of the construction of the PVC-based emergency contact tag shown in FIG. 1.

FIG. 5 is a perspective view, from the front, showing a person wearing the emergency contact tag around the waist in accordance with the preferred embodiment of the invention.

FIG. 6 is a perspective view, from the side, showing a person wearing the emergency contact tag on the arm or ankle in accordance with the preferred embodiment of the invention.

### DETAILED DESCRIPTION OF THE INVENTION

The present invention now will be described more fully hereinafter with reference to the accompanying drawings, in which preferred embodiments of the invention are shown. This invention may, however, be embodied in alternative forms and should not be construed as limited to the embodiments set forth herein. The emergency contact tag is preferably worn by athletes to provide first responders with critical emergency contact information and blood type in the case of an accident, however, it is worth noting that the invention can also be worn by any adult, elderly person or child that may not regularly carry suitable identification. The emergency contact tag described herein overcomes many of the drawbacks associated with current identification cards and tags.

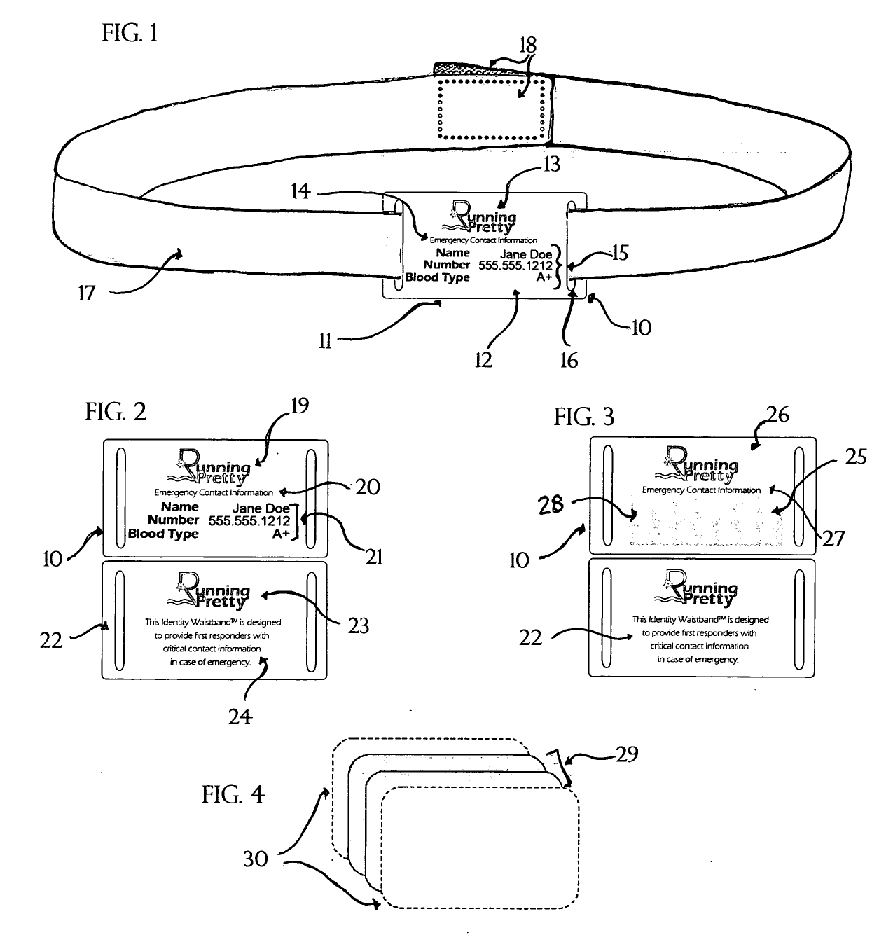

A wearable emergency contact tag 10 and a method for constructing the tag in accordance with the preferred embodiment of the invention are illustrated in FIGS. 1 through 6.

In FIG. 1, the wearable emergency contact tag 10 is constructed from Polyvinyl Chloride 11 or PVC and designed to be of a size 12 ranging from a 1 inch high by 2 inch wide by 1 millimeter thick to 1.5 inches high by 3 inches wide by 1 millimeter thick.

The wearable emergency contact tag 10 in this view includes room for logo or design at the top 13, a statement that clearly describes the usefulness of the tag 14 and necessary contact information about the wearer including but not limited to the wearer's name; an emergency contact phone number, and wearer's blood type 15 which is digitized and thermally printed onto the PVC-based emergency contact tag via computer using a card printer specifically designed to transfer ink to a plastic card using either dye sublimation or thermal transfer printing. The PVC-based has two slots 16 punched vertically out of its opposing sides.

An adjustable band or belt 17 is threaded through the vertical slots 16. The band or belt 17 can be produced in varying lengths depending on where the emergency contact tag is preferably attached. It is comprised of a flexible material including but not limited to nylon webbing or spandex with a hook and loop closure material 18 such as Velcro® attached at both ends.

FIG. 2 is an exploded view of the front of th wearable emergency contact tag 10 as described above and depicts the preferred embodiment of th reverse side of the emergency contact tag 10. At the top of the tag would be space for a thermally-printed logo or design 19, a statement that clearly describes the usefulness of the tag 20 and necessary contact information about the wearer including but not limited to the wearer's name; an emergency contact phone number; and wearer's blood type 21.

The reverse side of the emergency contact tag 22 has space for a thermally-printed logo or design 23 and would be thermally-printed with a statement 24 that clearly identifies it as an emergency contact tag providing critical information necessary to assist first responders in case of emergency.

FIG. 3 is an exploded view of the front of the wearable emergency contact tag 10 with the matte write-on surface 25. As described in FIG. 2, the top of the tag would include a space for a thermally-printed logo or design 26, a statement that clearly describes the usefulness of the tag 27 and a matte finish surface in which the wearer could write their necessary contact information including name; an emergency contact phone number; and wearer's blood type 28.

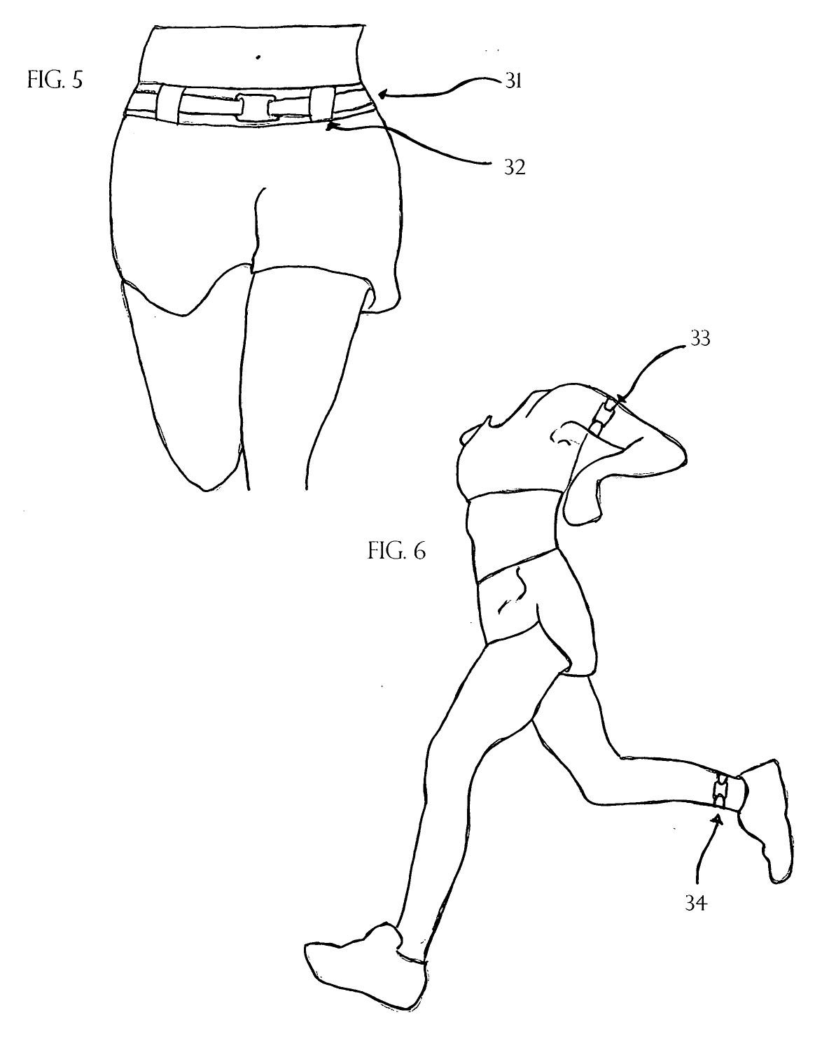

FIG. 4 is a detailed view of the construction of the Polyvinyl Chloride-based emergency contact tag shown in FIG. 1. The back and front layers of the PVC plastic card 29 are fused together by heat and pressure and are then covered by clear film laminate 30. These cards are produced in sheets and then cut to size.

FIG. 5 is a perspective view, from the front, showing a person wearing the emergency contact tag around the waist 31 in accordance with the preferred embodiment of the invention. In this perspective, the emergency contact tag, attached to a waist belt, is threaded through the belt loops 32 of a specially-designed athletic short. This embodiment is not, however, critical to the usefulness of the invention since the emergency contact tag and waistband attachment can be easily worn over a short, skirt, swim suit, or bare waist.

FIG. 6 is a perspective view, from the side, shoeing a person wearing the emergency contact tag on the arm 33 and ankle 34 in accordance with the preferred embodiment of the invention.

Many modifications and other embodiments of the invention will come to mind to one skilled in the art to which this invention pertains having the benefit of the teachings presented in the foregoing descriptions and the associated drawings. For example, the emergency contact tag could be attached to a waistband constructed of a material that coordinates with and attaches to a specific active wear garment through belt loops at the waist. Another example of an alternative embodiment would be a differing closure material or the use of an elastic-constructed waistband, ankle band or arm band. Although specific terms are employed herein, they are used in a generic and descriptive sense only and not for purposes of limitation.

What is claimed is:

1. A wearable emergency contact tag approximately 1 inch high by 2 inches wide by 1 millimeter thick comprised of Polyvinyl Chloride with two vertical slots punched into each end to which a belt or waistband can be threaded for means of attaching said emergency contact tag to the body.

2. The wearable emergency contact tag of claim 1, wherein Polyvinyl Chloride or PVC is the material of which the tag itself is constructed —the same material produced to generate credit cards, store loyalty cards, gift cards, corporate ID badges and more.

3. The wearable emergency contact tag of claim 2, wherein th Polyvinyl Chloride or PVC is designed to be of a size ranging from a 1 inch high by 2 inches wide by 1 millimeter thick to 1.5 inches high by 3 inches wide by 1 millimeter thick.

4. The wearable emergency contact tag of claim 3, wherein the tags are produced in any color PVC providing that the thermally-printed information is legible.

5. The wearable emergency contact tag of claim 2, wherein th wearer's emergency contact information would be digitized and thermally printed onto PVC-based emergency contact tag or applied using an indelible ink on a white, write-on matte surface.

6. The wearable emergency contact tag of claim 5, wherein the printed contact information would be completed by entering the information into a computer program and then transmitted to a plastic a card printer specifically designed to transfer ink to a plastic card using either dye sublimation or thermal transfer printing.

7. The wearable emergency contact tag of claim 5, wherein the wearer's emergency contact information would he hand-written with indelible ink on a white, write-on matte surface.

8. The wearable emergency contact tag of claim 6, wherein the following thermally-printed information is included: A statement that clearly describes the usefulness of the said emergency contact tag with language that indicate “Emergency Contact Information;” the wearer's name; an emergency contact phone number; wearer's blood type; other special medical needs.

9. The wearable emergency contact tag of claim 7, wherein the following thermally-printed information is included: A statement that clearly describes the usefulness of the said emergency contact tag with language that indicates “Emergency Contact Information” with the ability for the wearer to write a name; an emergency contact phone number; blood type; and other special medical needs directly on the card.

10. The wearable emergency contact tag of claim 5, wherein the reverse side would be thermally-printed with a statement that clearly identifies it as an emergency contact tag providing critical information necessary to assist first responders in case of emergency.

11. The wearable emergency contact tag of claim 2, wherein two slot openings, spanning approximately 80 percent of the height of the tag in a vertical direction and approximately 1 centimeter wide, would he punched on both ends.

12. An adjustable band or belt in varying lengths comprised of a flexible material including but not limited to nylon webbing or spandex, in which the emergency contact tag of claim 2 can be threaded through its vertical slots described in claim 11.

13. The adjustable band or belt of claim 12, wherein approximately 10 percent of the belt on both ends includes a hook and loop closure material such as Velcro®.
